(19) United States
(12) Patent Application Publication
(10) Pub. No.: US 2013/0162470 A1
(43) Pub. Date: Jun. 27, 2013

(54) Timing-Based Positioning Accuracy

(71) Applicants: Seppo Rousu, Oulu (FI); Antti Immonen, Helsinki (FI)

(72) Inventors: Seppo Rousu, Oulu (FI); Antti Immonen, Helsinki (FI)

(73) Assignee: Renesas Mobile Corporation

(21) Appl. No.: 13/342,329

(22) Filed: Jan. 3, 2012

(30) Foreign Application Priority Data
Dec. 22, 2011 (GB) 1122203.1

(51) Int. Cl. G01S 19/48; G01S 5/02

(52) U.S. Cl. 342/357.31; 342/450

(57) ABSTRACT

There are provided measures for enabling an improvement of timing-based positioning accuracy. Such measures may exemplarily include determining a delay value of a receiver path, via which a positioning-related signal is received, on the basis of at least one reception parameter, measuring a timing value for timing-based positioning calculation on the basis of the received positioning-related signal, and correcting the measured timing value on the basis of the determined delay value of the receiver path

### FIELD OF THE INVENTION

The present invention relates to an improvement of timing-based positioning accuracy. More specifically, the present invention relates to measures (including methods, apparatuses and computer program products) for enabling an improvement of timing-based positioning accuracy.

### BACKGROUND

In modern and future communication systems, location services and location-based services (LCS) are gaining more attention and importance. In order to enable provision of location services and location-based services for terminals in modern and future communication systems, an accurate positioning of the terminals is vital. An accurate positioning is for example particularly valuable in emergency use cases, under indoor conditions, urban canyons, tunnels, parking halls, subways, vehicles, and the like.

In the framework of 3GPP standardization, LTE control plane signaling support for LCS is introduced from 3GPP Release 9 onwards. Therein, assisted satellite positioning is specified as a primary positioning/localization technique, while both a cell ID based positioning and OTDOA-based positioning are specified as fallback positioning/localization techniques for the event that the terminal lacks satellite positioning capability or the assisted satellite positioning fails e.g. due to non-availability of a required number of positioning satellite signals.

The assisted satellite positioning is essentially based on at least four positioning satellite signals of GPS or any other satellite-based positioning system, while the network may provide assistance data for a reliable fix of the position.

The cell ID based positioning and enhancements thereof are essentially based on the fact that the responsible server (e.g. E-SMLC) knows the geographical locations of the cells, that the timing advance can be used to find a terminal's distance from each base station antenna in the vicinity, and that neighbor cell measurements and the like can be used to increase the accuracy of the positioned. That is to say, the consideration of neighbor cells enhances accuracy of positioning.

The OTDOA-based positioning is essentially based on the measurement of an observed time difference of arrival (OTDOA) on the basis of a positioning-related signal. In this regard, a terminal's position can be multi-laterated (mostly tri-laterated) with the knowledge of multiple (mostly three or more) base stations' transmit timings and their geographical locations and received time differences of at least two other cells relative to the serving cell of the terminal. In this regard, the terminal must detect positioning-related signals from multiple (mostly at least three) base stations in the vicinity.

Generally, when an increased accuracy of positioning results is desired in a specific communication system, the accuracy of positioning of at least one of the positioning/localization techniques specified for that specific communication system is to be improved. In view of the above, in the context of a 3GPP-based LTE communication system, the accuracy of positioning of at least one of assisted satellite positioning, the cell ID based positioning and the OTDOA-based positioning is to be improved.

The accuracy of positioning of the assisted satellite positioning and the cell ID based positioning may not be easily improved without requiring fundamental changes to the functional and/or structural configuration of the underlying satellite-based positioning system and communication system, respectively. Therefore, when an increased accuracy of positioning results is desired in a 3GPP-based LTE communication system, the accuracy of positioning of the OTDOA-based positioning is preferably to be improved.

Generally speaking, the positioning accuracy of a timing-based positioning technique (e.g. the OTDOA-based positioning technique) may typically be improved, while the positioning accuracy of infrastructure-based positioning technique is typically difficult to improve without effecting fundamental modifications to the underlying infrastructure.

Accordingly, in order to increase accuracy of positioning results is desired in a specific communication system, it is desirable to improve the positioning accuracy of a timing-based positioning technique therein, which may typically be achieved when improving the accuracy of the underlying timing and/or timing measurements e.g. at the terminal to be positioned or localized.

Thus, there is a desire to improve timing-based positioning accuracy.

### SUMMARY

Various exemplary embodiments of the present invention aim at addressing at least part of the above issues and/or problems and drawbacks.

Various aspects of exemplary embodiments of the present invention are set out in the appended claims.

According to an exemplary aspect of the present invention, there is provided a method comprising determining a delay value of a receiver path, via which a positioning-related signal is received, on the basis of at least one reception parameter, measuring a timing value for timing-based positioning calculation on the basis of the received positioning-related signal, and correcting the measured timing value on the basis of the determined delay value of the receiver path.

According to an exemplary aspect of the present invention, there is provided an apparatus comprising at least one processor, at least one memory including computer program code, and at least one interface configured for communication with at least another apparatus, the at least one processor, with the at least one memory and the computer program code, being configured to cause the apparatus to perform: determining a delay value of a receiver path, via which a positioning-related signal is received, on the basis of at least one reception parameter, measuring a timing value for timing-based positioning calculation on the basis of the received positioning-related signal, and correcting the measured timing value on the basis of the determined delay value of the receiver path.

According to an exemplary aspect of the present invention, there is provided a computer program product comprising computer-executable computer program code which, when the program is run on a computer (e.g. a computer of an apparatus according to the aforementioned apparatus-related exemplary aspect of the present invention), is configured to cause the computer to carry out the method according to the aforementioned method-related exemplary aspect of the present invention.

Such computer program product may comprise or be embodied as a (tangible) computer-readable (storage) medium or the like on which the computer-executable computer program code is stored, and/or the program may be directly loadable into an internal memory of the computer or a processor thereof.

Advantageous further developments or modifications of the aforementioned exemplary aspects of the present invention are set out in the following.

By way of exemplary embodiments of the present invention, there is provided an improvement of timing-based positioning accuracy (in/for cellular communication systems). More specifically, by way of exemplary embodiments of the present invention, there are provided measures and mechanisms for enabling an improvement of timing-based positioning accuracy (in/for cellular communication systems).

Thus, enhancements are achieved by methods, apparatuses and computer program products enabling an improvement of timing-based positioning accuracy (in/for cellular communication systems).

### BRIEF DESCRIPTION OF DRAWINGS

For a more complete understanding of exemplary embodiments of the present invention, reference is now made to the following description taken in connection with the accompanying drawings in which:

FIG. 1 shows a schematic diagram illustrating a system scenario of a timing-based positioning technique, for which exemplary embodiments of the present invention are applicable,

FIG. 2, comprising FIGS. 2a and 2b, shows schematic block diagrams illustrating exemplary configurations at an apparatus to be positioned, for which exemplary embodiments of the present invention are applicable,

FIG. 3 shows a graph depicting exemplary delay characteristics of a receiver path relative to an operating bandwidth,

FIG. 4 shows a flowchart of an example of a procedure at an apparatus to be positioned according to exemplary embodiments of the present invention,

FIG. 5 shows a flowchart of another example of a procedure at an apparatus to be positioned according to exemplary embodiments of the present invention,

FIG. 6 shows a flowchart of still another example of a procedure at an apparatus to be positioned according to exemplary embodiments of the present invention,

FIG. 7 shows a flowchart of an example of a delay value determination procedure at an apparatus to be positioned according to exemplary embodiments of the present invention, and

FIG. 8 shows a schematic block diagram illustrating exemplary apparatuses according to exemplary embodiments of the present invention.

### DESCRIPTION OF EXEMPLARY EMBODIMENTS

Exemplary aspects of the present invention will be described herein below. More specifically, exemplary aspects of the present are described hereinafter with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments. In particular, a LTE/LTE-Advanced communication system is used as a non-limiting example for the applicability of thus described exemplary embodiments. As such, the description of exemplary embodiments given herein specifically refers to terminology which is directly related thereto. Such terminology is only used in the context of the presented non-limiting examples, and does naturally not limit the invention in any way. Rather, any other network configuration or system deployment, etc. may also be utilized as long as compliant with the features described herein.

Hereinafter, various embodiments and implementations of the present invention and its aspects or embodiments are described using several alternatives. It is generally noted that, according to certain needs and constraints, all of the described alternatives may be provided alone or in any conceivable combination (also including combinations of individual features of the various alternatives).

According to exemplary embodiments of the present invention, in general terms, there are provided mechanisms, measures and means for enabling an improvement of timing-based positioning accuracy (in/for cellular communication systems).

In the following, exemplary embodiments of the present invention are described with reference to methods, procedures and functions, as well as with reference to structural arrangements and configurations.

More specifically, without restricting generality, the present invention and exemplary embodiments thereof are described with reference to an exemplary case of OTDOA-based positioning in a 3GPP-based LTE communication system. However, the present invention and exemplary embodiments thereof are equally applicable in/for any timing based positioning system, in any communication system or technology (including a downlink satellite communication system, a downlink/uplink satellite (e.g. GPS, Glonass, Galileo, etc.) communication system, a short range communication system, a cellular communication system) utilizing any timing-based positioning or localization technique.

In the following, where appropriate, OTDOA is adopted as a non-limiting example for a network-based/remote positioning technique, and GPS is adopted as a non-limiting example for a termina-based/local positioning technique.

In particular, while (remote) OTDOA-based positioning at the network side is taken as a non-limiting example herein, (local) GPS-based positioning at the apparatus to be positioned is also applicable in accordance with exemplary embodiments of the present invention. Also, a combination of both positioning techniques, i.e. a combined/integrated OTDOA- and GPS-based positioning, is applicable in accordance with exemplary embodiments of the present invention.

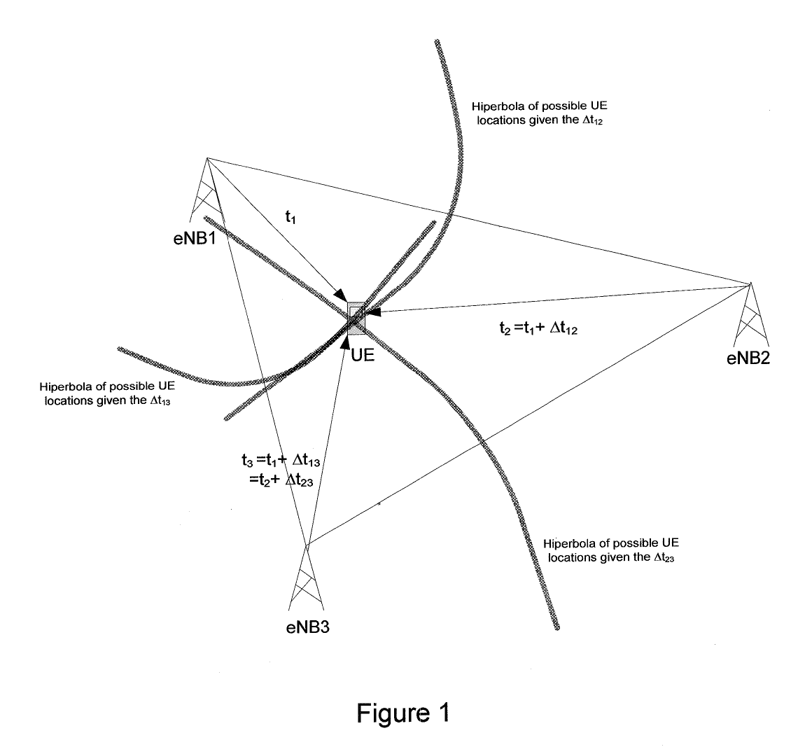

FIG. 1 shows a schematic diagram illustrating a system scenario of a timing-based positioning technique, for which exemplary embodiments of the present invention are applicable.

In the exemplary scenario according to FIG. 1, it is assumed that a terminal UE is to be positioned or localized using the OTDOA-based positioning with respect to three base stations or access nodes eNB1, eNB2, eNB3 serving cells of the underlying cellular communication system. For example, eNB1 may be assumed to be the base station or access node of the cell currently serving the UE, which may be used as a reference for OTDOA measurements. The base stations or access nodes respectively transmit positioning-related signals, such as PRS signals in the DL direction. The timing values relating to the individual base stations or access nodes, which are used for OTDOA-based positioning, are measured at the UE on the basis of the received positioning-related signals, and they are shown in their mutual relationship in FIG. 1.

In the OTDOA-based positioning, required neighbor cell information are provided from a server (not shown), such as an E-SMLC, to the UE. The UE measures the OTDOA timing values of each neighbor relative to the serving cell based on such neighbor cell information, such as base station physical cell IDs or global cell IDs, and provides the (corrected) measured OTDOA timing values and possibly some extracted information, such as base station physical cell IDs, global cell IDs and/or transmitting antenna IDs for timing measured signals, to the server for triangulating the UE position based thereon. The server then calculates the UE position, as indicated by a crossing point of three hyperbolas in FIG. 1, on the basis of the thus provided OTDOA timing values of the neighbor cells and the local knowledge of real cell positions and transmit timings.

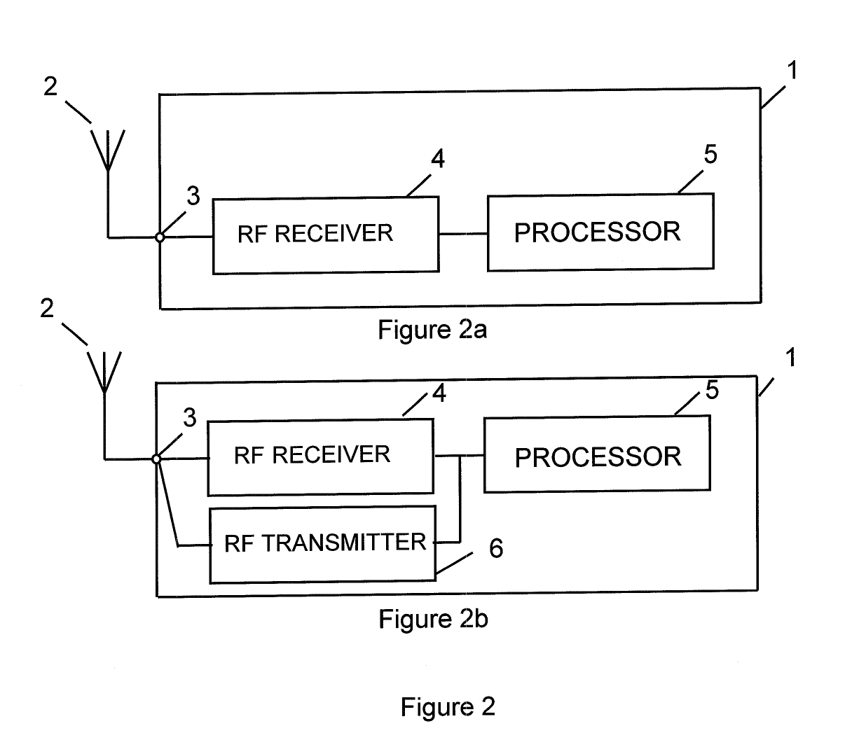

FIG. 2, comprising FIGS. 2a and 2b, shows schematic block diagrams illustrating exemplary configurations at an apparatus to be positioned, for which exemplary embodiments of the present invention are applicable. Referring to the exemplary scenario of FIG. 1, the apparatus to be positioned may be the UE.

FIG. 2a shows a schematic block diagram illustrating a receiver path at an apparatus to be positioned, for which exemplary embodiments of the present invention are applicable. The thus illustrated apparatus may for example comprise a GPS positioning device or the like, i.e. a device which locally performs timing-based positioning calculation on the basis of a satellite-originated positioning-related signal.

It is noted that the apparatus to be positioned may, at least in some exemplary embodiments, also have one or more other reception paths, which are not shown FIG. 2a. Alternate reception paths may be at the same frequency and/or an alternate frequency than first reception path. For example the apparatus may have a reception path or multiple reception paths for positioning signals at different frequencies, which may be one or more of GPS L1, GPS L2, GPS L5, Glonass, Galileo, FDD cellular frequencies, TDD cellular frequencies, or the like.

As shown in FIG. 2a, the apparatus 1 to be positioned may comprise an antenna 2 being connected via an antenna port or connector 3 to the internal receiver path being typically composed of an RF receiver means or circuitry 4 (possibly including receiver front-end means or circuitry) and a processor (e.g. a digital baseband) means or circuitry 5. Also, at least an interface between the antenna 2 and the RF receiver means or circuitry 4 and an interface between the RF receiver means or circuitry 4 and the processor 5 are included in the receiver path. Accordingly, any signal being received by the antenna is subject to a specific delay on the receiver path between the antenna port or connector 3 and the processor means or circuitry 5, which delay may depend from one or more parameters (referred to as reception parameters herein).

FIG. 2b shows a schematic block diagram illustrating a receiver path and a transmitter path at an apparatus to be positioned, for which exemplary embodiments of the present invention are applicable. The thus illustrated apparatus may for example comprise a device to be positioned by OTDOA or the like, i.e. a device for which timing-based positioning calculation is remotely performed at the network side on the basis of a network/cell-originated positioning-related signal, or a device to be positioned to be positioned by OTDOA or the like in combination with GPS, i.e. a GPS positioning device being additionally operable for OTDOA positioning.

It is noted that the apparatus to be positioned may, at least in some exemplary embodiments, also have one or more other reception and/or transmitter paths, which are not shown FIG. 2b. One or more other reception and/or transmitter paths may be at one operational frequency or multiple operational frequencies.

As shown in FIG. 2b, in addition to the antenna structure and the receiver path which basically correspond to the antenna structure and the receiver path shown and described according to FIG. 2a above, the apparatus 1 to be positioned may comprise an internal transmitter, to which the antenna 2 is also connected via the antenna port or connector 3. The internal transmitter path is typically composed of an RF transmitter means or circuitry 6 (possibly including transmitter front-end means or circuitry) and the processor (e.g. a digital baseband) means or circuitry 5. Accordingly, any signal to be transmitted proceeds via the transmitter path between the processor means or circuitry 5 and the antenna port or connector 3, which may also cause a delay similar to that in the receiver path (while such transmit delay is not specifically addressed in the present specification).

As evident from the following description, a transmitter path in an apparatus to be positioned is specifically usable for signaling (corrected) measured OTDOA timing values in the uplink direction towards the network, thereby enabling a position calculation at the network, e.g. the server.

It is noted that the apparatus to be positioned may, at least in some exemplary embodiments, have multiple (receive/transmit) antennas, a diversity antenna, MIMO antennas, alternate antennas, or the like at one or more operational frequencies, which is not shown in FIG. 2a or 2b.

It is further noted that in both configurations according to FIGS. 2a and 2b, for exemplary embodiments of the present invention, a distribution of certain parts (such as D/A or A/D converters) within the receiver path (i.e. between the RF receiver and the processor) and/or the transmitter path (i.e. between the processor and the RF transmitter) is insignificant and may be implementation-dependent. As mentioned above, the receiver path and/or the transmitter path may comprise analog interfaces and/or digital interfaces (such as e.g. DigRF) e.g. in or between the RF receiver and/or the processor and/or e.g. in or between the processor and the TX transmitter. Still further, the receiver path and/or the transmitter path (i.e. any one of the RF receiver, RF transmitter and the processor) may comprise software components operating on respective hardware components, such as e.g. control software running on a control unit, software-driven data buffering, or the like.

Accordingly, a receiver path configuration and/or a transmitter path configuration in the meaning of exemplary embodiments of the present invention may involve or factor in any one or any conceivable combination of the aforementioned features, aspects and properties.

In the OTDOA-based positioning, the relevant time difference for each neighbor cell is measured at a certain reference point which, in cellular communication devices/modems, typically is the antenna port or connector 3, while the time difference is actually measured at another point which, in cellular communication devices/modems, typically is the processor (e.g. the digital baseband) means or circuitry 5. As indicated by the RF receiver means or circuitry 4, there are typically multiple components/functional blocks for enabling various reception functionalities in the receiver path between the antenna port or connector 3 and the processor (e.g. the digital baseband) means or circuitry 5.

In the satellite-based (e.g. GPS) positioning, the relevant signal propagation time for each positioning (e.g. GPS) satellite is measured at a certain reference point which, in cellular communication devices/modems, typically is the antenna port or connector 3, while the signal propagation time is actually measured at another point which, in cellular communication devices/modems, typically is the processor (e.g. the digital baseband) means or circuitry 5. As indicated by the RF receiver means or circuitry 4, there are typically multiple components/functional blocks for enabling various reception functionalities in the receiver path between the antenna port or connector 3 and the processor (e.g. the digital baseband) means or circuitry 5.

In view thereof, the processor (e.g. the digital baseband) means or circuitry 5 according to exemplary embodiments of the present invention may be regarded as or may function as a positioning timing measurement circuitry.

Accordingly, a delay on the receiver path is caused by receiver hardware and/or software between a reference point for timing value measurement and a point of timing value measurement, depending on the applicable receiver path configuration.

Moreover, the delay on the receiver path (between a reference point for timing value measurement and a point of timing value measurement) of the apparatus to be positioned is typically not constant but varies for different reception parameters. This is essentially because different reception parameters could result in different delay characteristics of the receiver path or components/functional blocks thereof and/or different receiver path configurations with a different configuration of components/functional blocks and/or analog/digital interfaces being passed by the received signal. The receiver path or components/functional blocks thereof and/or different receiver path configurations are typically chipset (vendor) dependent.

The receiver path delay influences the timing properties of any received signal. In the context of any timing-based positioning technique (e.g. OTDOA-based and/or GPS-based positioning), such delay on the receiver path (between a reference point for timing value measurement and a point of timing value measurement) of the apparatus to be positioned adversely affects timing measurement accuracy and, thus, positioning accuracy.

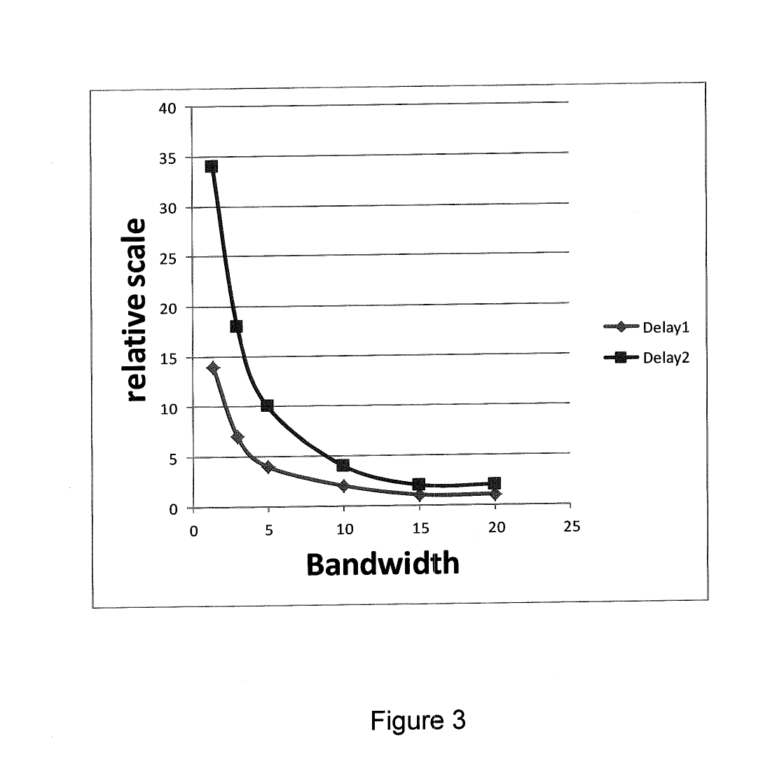

FIG. 3 shows a graph depicting exemplary delay characteristics of a receiver path relative to an operating bandwidth. In FIG. 3, an operating bandwidth is plotted on the abscissa and some relative scale indicative of a delay value on the receiver path is plotted on the ordinate, thus depicting bandwidth-related delay characteristics of a receiver path.

In FIG. 3, delay characteristic 1 refers to a case in which the receiver path does not involve a digital receiver front-end means or circuitry, while delay characteristic 2 refers to a case in which the receiver path involves a digital receiver front-end means or circuitry. As evident from the graph of FIG. 3, delay characteristics of a receiver path are dependent on an operating bandwidth of the receiving operation (e.g. a bandwidth of the received signal, such as a positioning-related signal).

In view of the above findings, exemplary embodiments of the present invention teach to take into account reception parameters influencing a delay of a receiver path (between a reference point for timing value measurement and a point of timing value measurement) at an apparatus to be positioned.

The methods, procedures and functions described hereinafter mainly relate to an apparatus to be positioned, e.g. a terminal. Such terminal may comprise a mobile station (MS) or a user equipment (UE) or a modem (which may be installed as part of a MS or UE, but may be also a separate module, which can be attached to various devices, like in an automotive environment). Such terminal or modem is configured to be operable in at least one given frequency range/band or multiple frequency allocations or multible bands or multiple radio access technologies. Generally, it is to be noted that, when reference is made herein to a terminal, MS or UE, such reference is equally applicable to a modem (which may be installed as part of a MS or UE, but may be also a separate module, which can be attached to various devices).

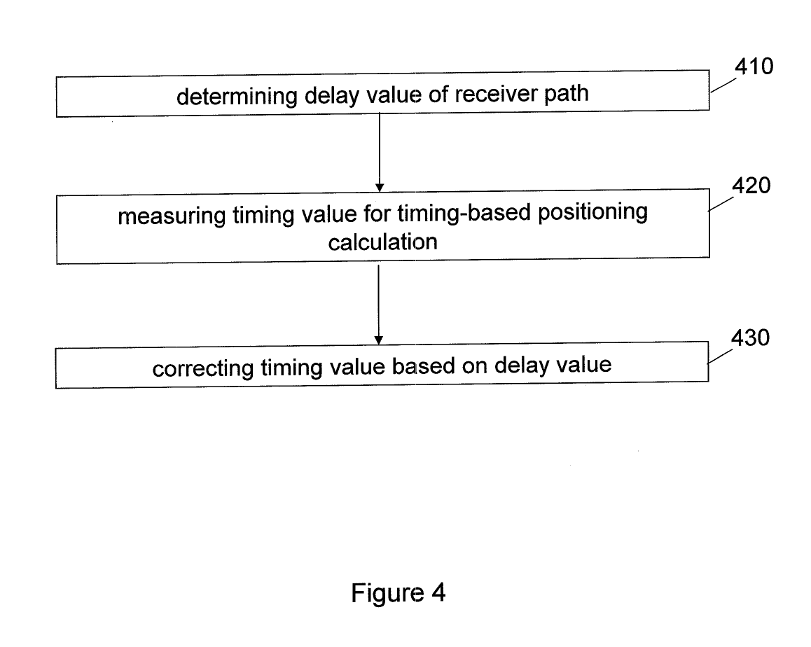

FIG. 4 shows a flowchart of an example of a procedure at an apparatus to be positioned according to exemplary embodiments of the present invention. The thus illustrated procedure may be carried out at any apparatus to be positioned, e.g. a terminal such as the UE according to FIG. 1. An apparatus to be positioned suitable for carrying out the thus illustrated procedure may be any apparatus to be positioned having at least one receiver path, e.g. a terminal, but does not necessarily has to comprise the receiver path as illustrated according to FIG. 2.

As shown in FIG. 4, a corresponding procedure according to exemplary embodiments of the present invention comprises an operation (410) of determining a delay value of a receiver path, via which a positioning-related signal is received, on the basis of at least one reception parameter, an operation (420) of measuring a timing value for timing-based positioning calculation on the basis of the received positioning-related signal, and an operation (430) of correcting the measured timing value on the basis of the determined delay value of the receiver path.

According to exemplary embodiments of the present invention, the at least one reception parameter comprises at least one reception parameter influencing a delay of the receiver path, i.e. a current, (currently) valid or (currently) operating reception parameter.

According to exemplary embodiments of the present invention, the correcting may be accomplished by adding the determined delay value to the measured timing value so as to derive a corrected timing value.

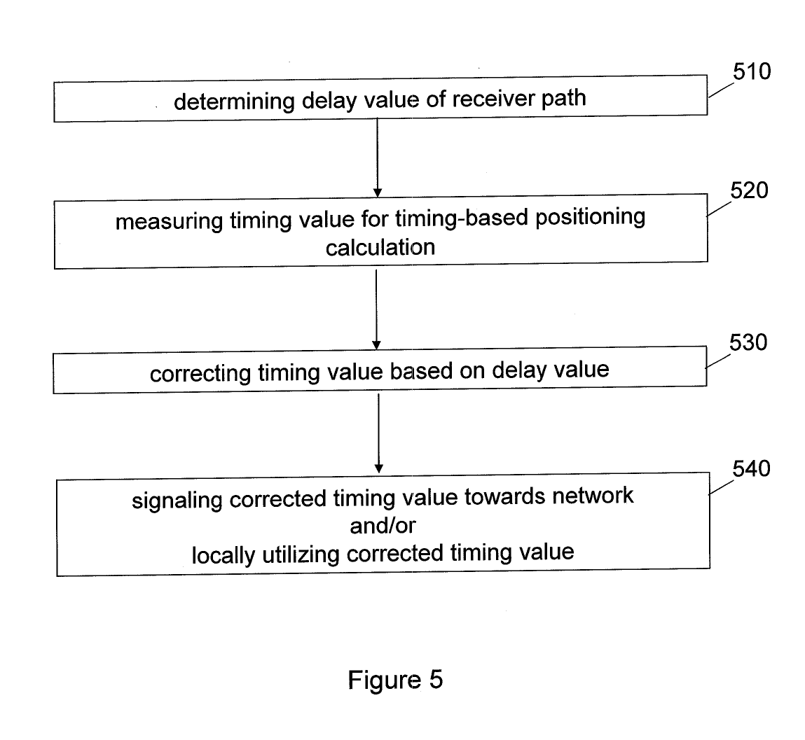

FIG. 5 shows a flowchart of another example of a procedure at an apparatus to be positioned according to exemplary embodiments of the present invention. Similar to FIG. 4, the thus illustrated procedure may be carried out at any apparatus to be positioned, e.g. a terminal such as the UE according to FIG. 1, and an apparatus to be positioned suitable for carrying out the thus illustrated procedure may any apparatus to be positioned having at least one receiver path, e.g. a terminal, but does not necessarily has to comprise a receiver path as illustrated according to FIG. 2a or a combination of receiver and transmitter paths as illustrated according to FIG. 2b.

As shown in FIG. 5, a corresponding procedure according to exemplary embodiments of the present invention comprises operations 510 to 530 which basically correspond to operations 410 to 430 according to FIG. 4, respectively. Accordingly, reference is made to the description of FIG. 4, and a detailed description of such basic operations is not repeated here. Further, the procedure comprises an operation (540) of signaling the corrected timing value (as well as, possibly, base station physical cell IDs, global cell IDs, transmitting antenna IDs for timing measured signals, frequencies of measured position related signals, direction of measured position related signals, special purposes information of measured position related signals, or the like) towards a network side for timing-based positioning calculation, and/or an operation (540) of utilizing the corrected timing value for timing-based positioning calculation (locally at the apparatus to be positioned). As explained below, the signaled/utilized corrected timing value may relate to the receiver path via which the positioning-related signal is received, or the signaled/utilized corrected timing value may relate to that one of multiple receiver paths via which the positioning-related signal is received, which exhibits the best timing accuracy among the multiple receiver paths, or the signaled/utilized corrected timing value may be weighted with a weight being indicative of the timing accuracy of the receiver path via which the positioning-related signal is received.

According to exemplary embodiments of the present invention, a signaling operation 540 is particularly applicable for an apparatus to be positioned by OTDOA or the like, i.e. a device for which timing-based positioning calculation is remotely performed at the network side on the basis of a network/cell-originated positioning-related signal (such as that according to FIG. 2b), and a utilization operation 540 is particularly applicable for a GPS positioning device or the like, i.e. a device which locally performs timing-based positioning calculation on the basis of a satellite-originated positioning-related signal (such as that of FIG. 2a). A combined signaling an utilization operation 540 is particularly applicable for a combination/integration of the aforementioned devices, i.e. an apparatus operable to be positioned by a network-based technique such as OTDOA and a satellite-based technique such as GPS, such as a GPS positioning device or the like which is to or may also be positioned by OTDOA or the like.

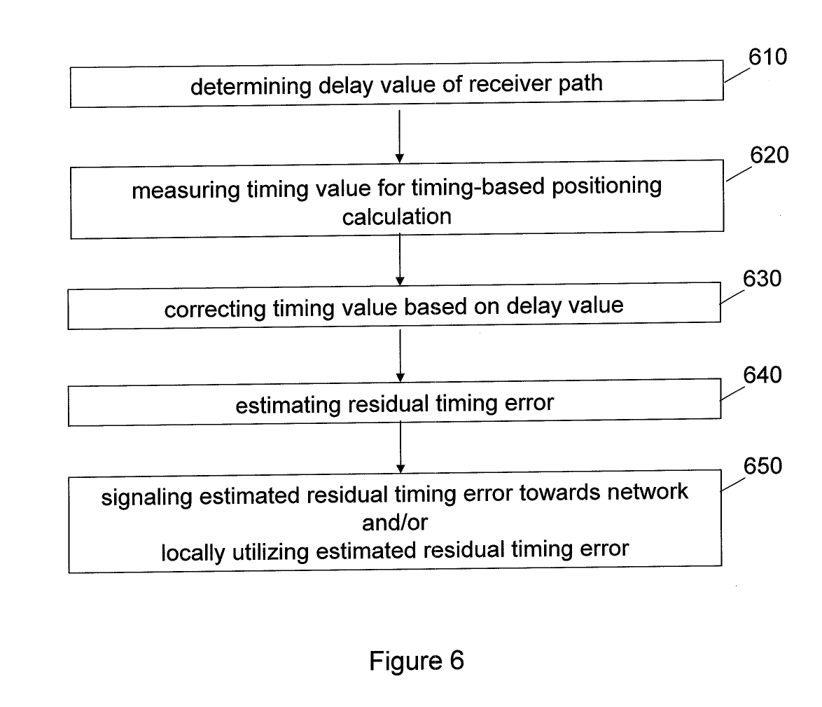

FIG. 6 shows a flowchart of still another example of a procedure at an apparatus to be positioned according to exemplary embodiments of the present invention. Similar to FIG. 4, the thus illustrated procedure may be carried out at any apparatus to be positioned, e.g. a terminal such as the UE according to FIG. 1, and an apparatus to be positioned suitable for carrying out the thus illustrated procedure may be any apparatus to be positioned having at least one receiver path, e.g. a terminal, but does not necessarily have to comprise a receiver path as illustrated according to FIG. 2a or a combination of receiver and transmitter paths as illustrated according to FIG. 2b.

As shown in FIG. 6, a corresponding procedure according to exemplary embodiments of the present invention comprises operations 610 to 630 which basically correspond to operations 410 to 430 according to FIG. 4, respectively. Accordingly, reference is made to the description of FIG. 4, and a detailed description of such basic operations is not repeated here. Further, the procedure comprises an operation (640) of estimating a residual timing error between the corrected timing value and an actual timing value, and an operation (650) of signaling the estimated residual timing error towards a network side for timing-based positioning calculation and/or an operation (650) of utilizing the estimated residual timing error for timing-based positioning calculation (locally at the apparatus to be positioned).

According to exemplary embodiments of the present invention, a signaling operation 650 is particularly applicable for an apparatus to be positioned by OTDOA or the like, i.e. a device for which timing-based positioning calculation is remotely performed at the network side on the basis of a network/cell-originated positioning-related signal (such as that according to FIG. 2b), and a utilization operation 650 is particularly applicable for a GPS positioning device or the like, i.e. a device which locally performs timing-based positioning calculation on the basis of a satellite-originated positioning-related signal (such as that of FIG. 2a). A combined signaling an utilization operation 650 is particularly applicable for a combination/integration of the aforementioned devices, i.e. an apparatus operable to be positioned by a network-based technique such as OTDOA and a satellite-based technique such as GPS, such as a GPS positioning device or the like which is to or may also be positioned by OTDOA or the like.

It is also conceivable that a base station may combine UE-estimated residual timing errors and base station-estimated residual timing errors for further processing. Such further processing may produce position-related probability vectors pointing to predefined directions, and the base station may send these position-related probability vectors as information to the UE. Directions of probability vectors may be one or more of roads, directions of base stations, north, east, west, south, or any intermediate direction etc.

The aforementioned residual timing error may for example be defined as a percentage of UE delay in different configurations. Such percentage values may be taken from look-up tables or may be included in computation SW code, or the like.

According to exemplary embodiments of the present invention, an estimated and signaled timing residual error may be a single value of a single measurement, an error range/interval (including upper- and lower-side values and/or an error amount) of a single measurement, an average value of multiple measurements, any combination thereof, or the like.

According to exemplary embodiments of the present invention, the server may calculate the UE position with or without error vectors of the calculated UE position, and inform those to the UE as a response to a positioning request or the like. Further, the UE may present the received position or the received position with error vectors on a user interface such as e.g. a display, a touch display, a screen etc, with or without map information, on a map or not, and so on.

According to exemplary embodiments of the present invention, the exemplary procedures according to FIGS. 5 and 6 may also be combined, thus basically comprising operations 410 to 430 according to FIG. 4, operation 540 according to FIG. 5, and operations 640 and 650 according to FIG. 6.

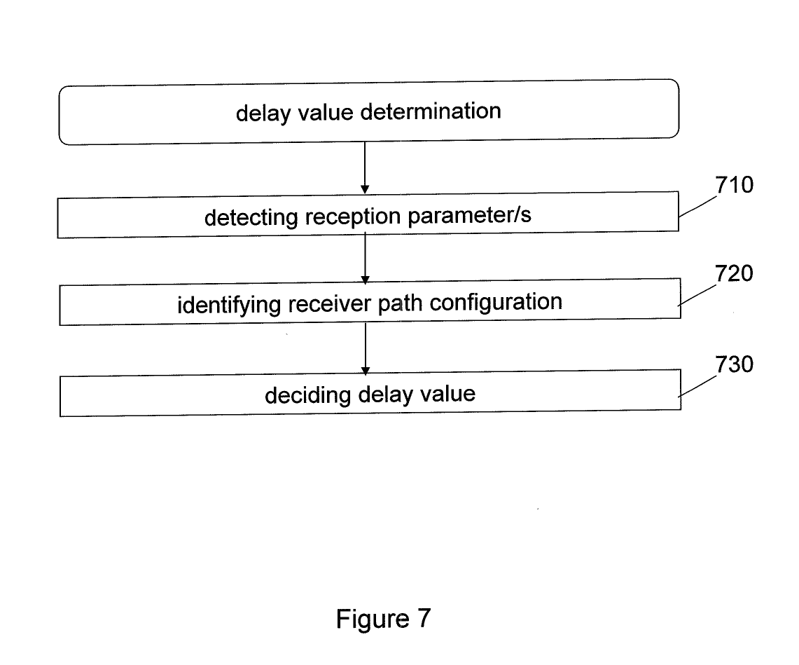

FIG. 7 shows a flowchart of an example of a delay value determination procedure at an apparatus to be positioned according to exemplary embodiments of the present invention.

The thus illustrated procedure is a non-limiting example for determining a delay value of a receiver path, and may thus be carried out within any one of the operations 410, 510 and 610, i.e. at the apparatus carrying out the procedure according to any one FIGS. 4 to 6, respectively. Accordingly, the procedure according to FIG. 7 may be combined with any one of the procedure according to FIGS. 4 to 6.

As shown in FIG. 7, an operation of determining a delay value of a receiver path according to exemplary embodiments of the present invention comprises an operation (710) of detecting the at least one reception parameter used in receiving the positioning-related signal, an operation (720) of identifying a receiver path configuration corresponding to the detected at least one reception parameter, and an operation (730) of deciding the delay value on the basis of the identified receiver path configuration.

According to exemplary embodiments of the present invention, one or both of the operations 720 and 730 may be accomplished by using a look-up table or any other storage location, which stores information relating to a relationship between the respective parameters to be mapped/associated, i.e. pre-specified values of such relationship. Namely, the operation 720 may comprise looking up the receiver path configuration as a function of the detected at least one reception parameter in a look-up table or any other storage location, and/or the operation 730 may comprise looking up the delay value as a function of the identified receiver path configuration in a look-up table or any other storage location. Such look-up tables or other storage locations may be those being (defined to be) used in corresponding algorithm loops.

According to exemplary embodiments of the present invention, the operation 730 may be accomplished by using a relationship between the identified receiver path configuration and the thus relevant delay value of the receiver path, which is defined on the basis of at least one of a mathematical model and performance measurement results. Thereby, adjustments needed to improve timing accuracy may be defined by at least one of a mathematical model and/or performance measurement results and/or production test results. In this regard, applicable mathematical models exhibiting the relevant relationship, which may be theoretically founded on the basis of (datasheet-based) circuitry or component properties, may for example be implemented to modem hardware and/or software and/or algorithms. Further, applicable performance measurement results exhibiting the relevant relationship may for example be practically derived from performance testing of actual circuitry or component properties of circuitry or components being built in the receiver path of a tested apparatus or means/circuitry/modem/algorithm thereof or the like. Such performance testing may be carried out for example already in the context of research and development by modem performance measurements with respect to different receiver path configurations, by production tuning and testing results for different configurations (which is particularly useful for special cases if some components have more variation), etc, as well as combinations of the above. Accordingly, it is feasible to utilize performance measurement results for improving timing and, thus, positioning accuracy, which as such are already available for any apparatus as an outcome of usual R&D and/or production testing measures.

According to exemplary embodiments of the present invention, the determined delay value and, thus, the corrected timing value may be exactly correct. Yet, in view of practical restrictions influencing accuracy (e.g. the infeasibility of implementing a full model or acquiring fully correct performance measurement results for calculation purposes), it may be the case that the determined delay value and, thus, the corrected timing value may not be exactly correct, but there remains a residual error. In such cases, the aforementioned operations 640 and 650 according to FIG. 6 are especially effective.

According to exemplary embodiments of the present invention, communication payload and timing information may share the same communication channel, as is the case e.g. in LTE. Accordingly, timing information may be transmitted concurrently with communication payload, or timing information may be transmitted between communication payload periods, or only timing information may be transmitted (e.g. for a specific period), or the like. In the downlink direction, the timing information may for example comprise a positioning-related signal. In the uplink direction, the timing information may for example comprise signaling information of the corrected timing value and/or the estimated residual timing error.

According to exemplary embodiments of the present invention, the at least one reception parameter is generally indicative of a delay on the receiver path, which is caused by receiver hardware and/or software and/or controls between a reference point for timing value measurement and a point of timing value measurement in the receiver path. The influence of receiver hardware and/or software on the delay on the receiver path may generally be due to different characteristics of components/functional blocks for different reception parameters and/or different timings of components/functional blocks for different reception parameters and/or the applicability/involvement of different components/functional blocks in the receiver path (e.g. in the RF receiver means or circuitry) for different reception parameters.

Generally speaking, the at least one reception parameter may comprise one or more of operating bandwidth(s), receiver path identifier(s), frequency/frequencies, carrier aggregation frequency configuration(s), switch control information, filter control information, antenna control information, a number of carrier aggregation components, (frequency) band(s),a number of subcarriers at an operating bandwidth, a positioning of subcarriers at an operating bandwidth, active receiver function setup(s), passive receiver function setup(s), digital interface setup(s), digital filter setup(s), AGC setup(s), mixer setup(s), analog filter setup(s), digital receiver setup(s), analog receiver setup(s), passive receiver front-end setup(s), a digital modem setup(s), and an active receiver front-end setup, or the like. Setups may be altered according one or more of an operating bandwidth, a receiver path identifier, a frequency, carrier aggregation frequency configuration, a switch control information, a filter control information, an antenna control information, number of carrier aggregation components, a (frequency) band, a number of subcarriers at an operating bandwidth, a positioning of subcarriers at an operating bandwidth, timing information(s), timing variation information(s), or the like.

According to exemplary embodiments of the present invention, components/functional blocks, which may have effect to a receiver path delay and, thus, may be taken into consideration in this regard, may comprise one or more of antenna setup, front end routing setup, LNA setup(s), transferred-impedance filter setup(s), up-conversion mixer setup(s), down-conversion mixer setup(s), intermediate variable gain amplifier setup(s), direct conversion demodulator setup(s), intermediate conversion demodulator setup(s), buffer setup(s), capacitor matrix setup(s), switch setup(s), data buffer setup(s), filter corner frequency setup(s), filter type and order setup(s), bypassed filter setup(s), operation duty cycle setup(s), local phase shifting setup(s), trans-impedance gain setup(s), impedance setups, I and Q channel setup(s), RC filter setup(s), bandwidth setup(s), mode setup(s), 2G/3G/LTE setup(s), filter response setup(s), tunable resistors setup(s), DC (direct current) compensation setup(s), signal sampling setup(s), averaging setup(s), digital and/or analog amplitude scaling setup(s), timing information(s) setup(s), timing variation information(s) setup(s), or the like.

More specifically, receiver path related timing/phase variations may be due to the following considerations, effects and relations.

Regarding bandwidth-related characteristics, consideration of the operating bandwidth is particularly effective in communication systems being capable of using plural signal bandwidths. For example, 3GPP-based LTE communication systems may be operable on various signal bandwidths, and the RF receiver delay may be different for the different signal bandwidths, e.g. for 1.4, 5, 10, 20, 40, 100 MHz according to communication system configuration. The bandwidth-related delay may specifically apply to different operating bandwidths in the section between the RF receiver front end/RF receiver and the processor. It may depend on an operating bandwidth of a FIR filter (FIR: Finite Impulse Response), may depend on an operating bandwidth of a SINC filter, and/or may depend on an operating bandwidth of RX DFE (i.e. a digital front-end of the receiver).

Further, delay characteristics of the receiver path may depend on a number of subcarriers at an operating bandwidth.

Still further, delay characteristics of the receiver path may depend on a setup of the receiver path, e.g. in terms of an active receiver function setup and/or an active receiver front-end setup. Such receiver setups may impact the delay on the receiver path as follows.

If some functionality (e.g. some component/functional block) is not used but is bypassed, the delay will be changed due to avoidance of any processing delay of the bypassed functionality (e.g. some component/functional block). Further, the RF front end may have alternative receiver signal paths, wherein alternative signal paths may be due to interoperability. In this regard, split band filters may be implemented e.g. due to technology limitations, thus leading to different signal paths for different bandwidths. Still further, alternate antennas and/or intra/inter-band reception may provide for multiple signal paths.

The number and type of active front end components alter phases and/or timings of received signals including positioning-related signals.

In this regard, a gain adjustment in a RF receiver chain may alter phases and/or timings according to a power level of the received signals, wherein LNAs within the RF receiver and/or external LNAs may influence the delay characteristics (LNA: low-noise amplifier). External LNAs may be applicable in some implementations to compensate for front end losses, e.g. in an automobile environment, when multiple antennas for MIMO functionality are present and/or the length of cables may (significantly) vary in length. Further influencing factors in this regard may comprise one of more of adjustable filtering bandwidths according to communication signals, adaptive antenna matching units compensating for bad transmission/reception VSWR (voltage standing wave ratio) conditions by adjusting impedances of antenna circuitry, alternative RX antennas routings, switch components group delay altering according to how many poles are concurrently active (wherein this factor may be relevant in carrier aggregation), and tunable front end filter responses varying according to how those are adjusted (e.g. on left/mid/right edge of band, TDD/FDD filtering mode according to use case, according to band in FDD, according to band in TDD mode).

In summary, all of the aforementioned considerations, effects and relations could be used as or for the at least one reception parameter to be applied in procedures according to exemplary embodiments of the present invention. Accordingly, timing accuracy and, thus, positioning accuracy may be improved according to exemplary embodiments of the present invention in that variations of delay characteristics (including timing/phase variations) due to one or more of the aforementioned factors may be omitted.

According to exemplary embodiments of the present invention, the exemplary procedures according to FIGS. 4 to 7 enable that a corrected timing value is communicated to uplink (e.g. to a server such as an E-SMLC) for location calculations, which takes into account reception parameters influencing a delay of a receiver path (between a reference point for timing value measurement and a point of timing value measurement). Accordingly, the positioning-related timing parameter reported in the UL direction towards the network exhibits an increased accuracy in terms of timing, thus enabling a network-based positioning calculation with an increased accuracy in terms of positioning.

According to exemplary embodiments of the present invention, in the signaling of the corrected timing value in the operation 540 according to FIG. 5 and/or the signaling of the estimated residual timing error in the operation 650 according to FIG. 6, information in view of a plurality of available/applicable receiver path configurations or signal paths may be taken into consideration. For example, when more than one receiver path configuration or signal path is available/applicable for a positioning-related signal to be processed, the signaled timing value may be reported from/for a path which is known/evaluated to provide for the best timing accuracy among the available/applicable paths, and/or the signaled timing value may be reported in a weighted form with the weight being indicative of the timing accuracy of the used path among the available/applicable paths. Accordingly, the apparatus carrying out the procedure according to FIG. 5 or 6 comprises evaluation functionality (i.e. corresponding means or circuitry) for evaluating timing accuracy for the receiver path/s via which a positioning-related signal is received, wherein the path with the best timing accuracy among the available/applicable paths and/or a weight being indicative of the timing accuracy of the used path may be evaluated.

According to exemplary embodiments of the present invention, the timing value may be measured by using one of an intra-frequency or single-carrier measurement, an inter-frequency or multiple-carrier measurement and a measurement on carrier aggregation components.

When the reference cell and the neighbor cells are operating at the same carrier, i.e. the timing value is measured by using an intra-frequency or single-carrier measurement, a timing difference is not real if there is a change in RF front end path delay/phases at duration of measurement (e.g. gain for different carriers).

When the reference cell and the neighbor cells are operating at different carriers, i.e. the timing value may be measured by using an inter-frequency or multiple-carrier measurement, there may be a timing variation between carriers.

When the reference cell and the neighbor cells are operating with carrier aggregation, i.e. the timing value may be measured by using measurement on carrier aggregation components, there may be a timing variation between carrier aggregation components.

It is to be noted that, by way of example and for the sake of simplicity, the exemplary procedures according to FIGS. 4 to 7 are described for a processing of a single positioning-related signal at an apparatus to be positioned. Yet, in view of the description of OTDOA-based positioning with reference to FIG. 1 above, it is obvious that such procedures equally apply for a (parallel or successive) processing of plural positioning-related signals at an apparatus to be positioned. Namely, the exemplary procedures according to FIGS. 4 to 7 may be equally applied to all positioning-related signals received at an apparatus to be positioned, e.g. PRS signals from base stations or access nodes eNB1, eNB2 and eNB3 according to the scenario of FIG. 1. In such case, the described signal processing according to FIGS. 4 to 7 is applied to any one of the received signals in a parallel or successive manner.

It is further to be noted that the above description exemplary refers to an exemplary case of OTDOA-based positioning, in which the timing value comprises an observed time difference of arrival with respect to a reference cell. However, the present invention and its embodiments are equally applicable in/for any timing-based positioning or localization (such as e.g. car radar systems or other automotive applications), as long as some timing value for timing-based positioning calculation is derived on the basis of a received positioning-related signal.

It is also noted that the above-described procedures and functions may be implemented in a software manner, e.g. in a modem software, modem algorithms, without affecting a hardware configuration of the apparatus to be positioned.

In view of the above, exemplary embodiments of the present invention enable to increase positioning accuracy in a timing-based positioning technique by improving timing accuracy of a timing value used in this regard. Accordingly, a timing value on the basis of a positioning-related signal (e.g. PRS) may be measured with improved accuracy, while taking into account one or more reception parameters influencing a delay of a receiver path (between a reference point for timing value measurement and a point of timing value measurement) at an apparatus to be positioned.

Stated in other words, according to exemplary embodiments of the present invention, an apparatus to be positioned is capable of combining information on a delay caused on a receiver path with a timing measurement result based on a positioning-related signal, thereby correcting the timing measurement result in accordance with delay characteristics of the receiver path in the apparatus to be positioned.

Generally, the above-described procedures and functions may be implemented by respective functional elements, processors, or the like, as described below.

While in the foregoing exemplary embodiments of the present invention are described mainly with reference to methods, procedures and functions, corresponding exemplary embodiments of the present invention also cover respective apparatuses, network nodes and systems, including both software and/or hardware thereof.

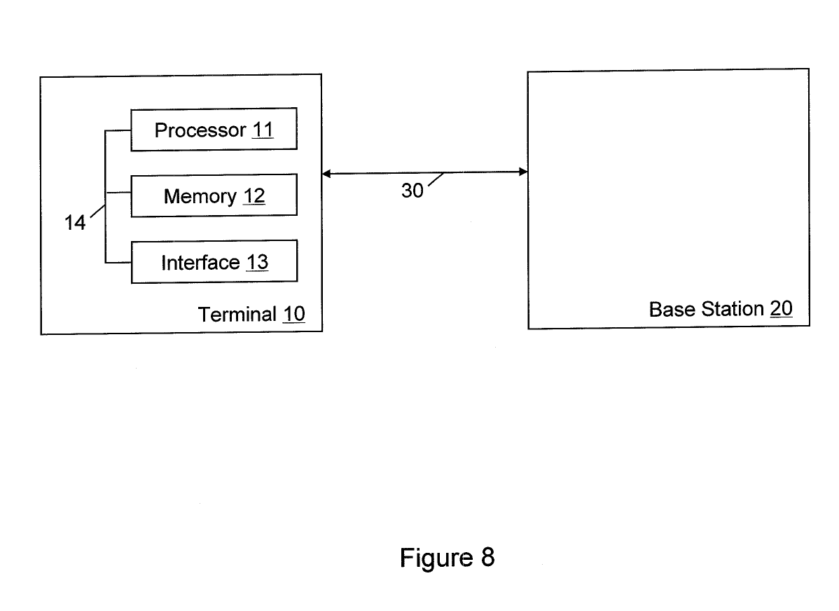

Respective exemplary embodiments of the present invention are described below referring to FIG. 8, while for the sake of brevity reference is made to the detailed description with regard to FIGS. 1 to 7.

In FIG. 8 below, which is noted to represent a simplified block diagram, the solid line blocks are basically configured to perform respective operations as described above. The entirety of solid line blocks are basically configured to perform the methods and operations as described above, respectively. With respect to FIG. 8, it is to be noted that the individual blocks are meant to illustrate respective functional blocks implementing a respective function, process or procedure, respectively. Such functional blocks are implementation-independent, i.e. may be implemented by means of any kind of hardware or software, respectively. The arrows and lines interconnecting individual blocks are meant to illustrate an operational coupling there-between, which may be a physical and/or logical coupling, which on the one hand is implementation-independent (e.g. wired or wireless) and on the other hand may also comprise an arbitrary number of intermediary functional entities not shown. The direction of arrow is meant to illustrate the direction in which certain operations are performed and/or the direction in which certain data is transferred.

Further, in FIG. 8, only those functional blocks are illustrated, which relate to any one of the above-described methods, procedures and functions. A skilled person will acknowledge the presence of any other conventional functional blocks required for an operation of respective structural arrangements, such as e.g. a power supply, a central processing unit, respective memories or the like. Among others, memories are provided for storing programs or program instructions for controlling the individual functional entities to operate as described herein.

FIG. 8 shows a schematic block diagram illustrating exemplary apparatuses according to exemplary embodiments of the present invention.

In view of the above, the thus described apparatuses 10 and 20 are suitable for use in practicing the exemplary embodiments of the present invention, as described herein. The thus described apparatus 10 may represent a (part of a) terminal such as a mobile station MS or user equipment UE or a modem (which may be installed as part of a MS or UE, but may be also a separate module, which can be attached to various devices, as described above, and may exhibit a configuration as described in conjunction with FIG. 2 and/or may be configured to perform a procedure and/or functionality as described in conjunction with any one of FIGS. 4 to 7. The thus described apparatus 20 may represent a (part of a) network entity, such as base station or access node or any network-based controller, e.g. an eNB or a E-SMLC.

A terminal according to exemplary embodiments of the present invention may for example comprise any (short range, cellular, satellite, etc.) wireless communication device such as car communication devices, mobile phones, smart phones, communicators, USB devices, laptops, finger computers, machine-to-machine terminals, device-to-device terminals, vehicle-to-vehicle terminals, vehicle-to-infrastructure, vehicle-to-roadside, routers, terminals of pico/micro/femto cells and the like with wireless communication capability, and so on.

As shown in FIG. 8, according to exemplary embodiments of the present invention, the terminal 10 comprises a processor 11, a memory 12, and an interface 13, which are connected by a bus 14 or the like, and may be connected with the network entity 20 through a link or connection 30.

The memory 12 may store respective programs assumed to include program instructions that, when executed by the associated processor 11, enable the respective electronic device or apparatus to operate in accordance with the exemplary embodiments of the present invention. For example, the memory 12 of the terminal 10 may store the aforementioned look-up table/s or comprise the aforementioned storage location/s.

The processor 11 and/or the interface 13 may be facilitated for communication over a (hardwire or wireless) link, respectively. The interface 13 may comprise a suitable receiver or a suitable transmitter-receiver combination or transceiver, which is coupled to one or more antennas or communication means for (hardwire or wireless) communications with the linked or connected device(s), respectively. The interface 13 is generally configured to communicate with another apparatus, i.e. the interface thereof.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

According to exemplary embodiments of the present invention, an apparatus representing the terminal 10 comprises at least one processor 11, at least one memory 12 including computer program code, and at least one interface 13 configured for communication with at least another apparatus. The processor (i.e. the at least one processor 11, with the at least one memory 12 and the computer program code) is configured to perform determining a delay value of a receiver path, via which a positioning-related signal is received, on the basis of at least one reception parameter, measuring a timing value for timing-based positioning calculation on the basis of the received positioning-related signal, and correcting the measured timing value on the basis of the determined delay value of the receiver path.

According to exemplary embodiments of the present invention, the processor (i.e. the at least one processor 11, with the at least one memory 12 and the computer program code) may be configured to perform: detecting the at least one reception parameter used in receiving the positioning-related signal, identifying a receiver path configuration corresponding to the detected at least one reception parameter, deciding the delay value on the basis of the identified receiver path configuration. Therein, the deciding the delay value on the basis of the identified receiver path configuration may be accomplished by using a relationship being defined on the basis of at least one of a mathematical model and performance measurement results, and/or the deciding the delay value may be accomplished by looking up the delay value as a function of the identified receiver path configuration in a look-up table, and/or the identifying the receiver path configuration may be accomplished by looking up the receiver path configuration as a function of the detected at least one reception parameter in a look-up table.

According to exemplary embodiments of the present invention, the processor (i.e. the at least one processor 11, with the at least one memory 12 and the computer program code) may be configured to perform:
signaling the corrected timing value towards a network side for timing-based positioning calculation and/or utilizing the corrected timing value for timing-based positioning calculation (i.e. performing timing-based positioning calculation utilizing the corrected timing value), wherein the signaled/utilized corrected timing value relates to the receiver path via which the positioning-related signal is received, or the signaled/utilized corrected timing value relates to that one of multiple receiver paths via which the positioning-related signal is received, which exhibits the best timing accuracy among the multiple receiver paths, or the signaled/utilized corrected timing value is weighted with a weight being indicative of the timing accuracy of the receiver path via which the positioning-related signal is received, and/or
estimating a residual timing error between the corrected timing value and an actual timing value,, and signaling the estimated residual timing error towards a network side for timing-based positioning calculation and/or utilizing the estimated residual timing error for timing-based positioning calculation (i.e. performing timing-based positioning calculation utilizing the estimated residual timing error).

According to exemplary embodiments of the present invention, timing-based positioning may be based on a network-based approach or a satellite-based approach. In the network-based approach, the timing value may comprise an observed time difference of arrival with respect to a reference cell, and/or the positioning-related signal may comprise a positioning reference signal from one of a serving cell and a neighboring cell. In the satellite- based approach, the timing value may comprise a signal propagation time with respect to a positioning satellite, and/or the positioning-related signal may comprise a positioning reference signal from a positioning satellite.

According to exemplarily embodiments of the present invention, a system may comprise any conceivable combination of the thus depicted devices/apparatuses and other network elements, which are configured to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any procedural step or functionality is suitable to be implemented as software or by hardware without changing the idea of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, the present invention and/or exemplary embodiments thereof provide measures for enabling an improvement of timing-based positioning accuracy. Such measures may exemplarily comprise determining a delay value of a receiver path, via which a positioning-related signal is received, on the basis of at least one reception parameter, measuring a timing value for timing-based positioning calculation on the basis of the received positioning-related signal, and correcting the measured timing value on the basis of the determined delay value of the receiver path

Even though the present invention and/or exemplary embodiments are described above with reference to the examples according to the accompanying drawings, it is to be understood that they are not restricted thereto. Rather, it is apparent to those skilled in the art that the present invention can be modified in many ways without departing from the scope of the inventive idea as disclosed herein.

### LIST OF ACRONYMS AND ABBREVIATIONS

AGC Automatic Gain Control

DFE Digital Front-End

DL Downlink

eNB evolved Node B (E-UTRAN base station)

E-SMLC Evolved Serving Mobile Location Center

FDD Frequency Division Duplex

FE Front-End

FIR Finite Impulse Response

GPS Global Positioning System

LCS Location Service/Location-based Service

LNA Low-Noise Amplifier

LTE Long Term Evolution

LTE-A Long Term Evolution Advanced

MIMO Multiple-Input Multiple-Output

OTDOA Observed Time Difference of Arrival

PRS Positioning Reference Signal

RF Radio Frequency

RX Receiver

TDD Time Division Duplex

UE User Equipment

UL Uplink

USB Universal Serial Bus

VSWR Voltage Standing Wave Ratio

1. A method comprising:
determining a delay value of a receiver path, via which a positioning-related signal is received, on the basis of at least one reception parameter,
measuring a timing value for timing-based positioning calculation on the basis of the received positioning-related signal, and
correcting the measured timing value on the basis of the determined delay value of the receiver path,
wherein the at least one reception parameter comprises an operating bandwidth.

2. The method according to claim 1, wherein the step of determining the delay value of the receiver path comprises:
detecting the at least one reception parameter used in receiving the positioning-related signal,
identifying a receiver path configuration corresponding to the detected at least one reception parameter, and
deciding the delay value on the basis of the identified receiver path configuration.

3. The method according to claim 2, wherein
the delay value is decided on the basis of the identified receiver path configuration by using a relationship defined on the basis of at least one of a mathematical model and performance measurement results, and/or
the delay value is decided by looking up the delay value as a function of the identified receiver path configuration in a look-up table, and/or
the receiver path configuration is identified by looking up the receiver path configuration as a function of the detected at least one reception parameter in a look-up table.

4. (canceled)

5. The method according to claim 1, wherein
the method further comprises signaling the corrected timing value towards a network side for timing-based positioning calculation, wherein the signaled corrected timing value relates to the receiver path via which the positioning-related signal is received, or the signaled corrected timing value relates to the receiver path of multiple receiver paths via which the positioning-related signal is received, which exhibits the best timing accuracy among the multiple receiver paths, or the signaled corrected timing value is weighted with a weight being indicative of the timing accuracy of the receiver path via which the positioning-related signal is received, and/or
the timing value comprises an observed time difference of arrival with respect to a reference cell, and/or
the positioning-related signal comprises a positioning reference signal from one of a serving cell and a neighboring cell.

6. The method according to claim 1, wherein
the method further comprises utilizing the corrected timing value for timing-based positioning calculation, wherein the utilized corrected timing value relates to the receiver path via which the positioning-related signal is received, or the utilized corrected timing value relates to the receiver of multiple receiver paths via which the positioning-related signal is received, which exhibits the best timing accuracy among the multiple receiver paths, or the utilized corrected timing value is weighted with a weight being indicative of the timing accuracy of the receiver path via which the positioning-related signal is received, and/or
the timing value comprises a signal propagation time with respect to a positioning satellite, and/or
the positioning-related signal comprises a positioning reference signal from a positioning satellite.

7. The method according to claim 1, further comprising
estimating a residual timing error between the corrected timing value and an actual timing value, and
signaling the estimated residual timing error towards a network side for timing-based positioning calculation or utilizing the estimated residual timing error for timing-based positioning calculation.

8. The method according to claim 1, wherein the timing value is measured by using one of an intra-frequency or single-carrier measurement, an inter-frequency or multiple-carrier measurement and a measurement on carrier aggregation components, and/or
the delay value of the receiver path represents a delay caused by receiver hardware and/or software between a reference point for timing value measurement and a point of timing value measurement in the receiver path.

9. The method according to claim 1, wherein
the method is operable at or by a terminal, user equipment, mobile station or modem, and/or
the method is operable in at least one of a LTE and a LTE-A cellular system.

10. An apparatus comprising:
at least one processor,
at least one memory including computer program code, and
at least one interface configured for communication with at least another apparatus,
the at least one processor, with the at least one memory and the computer program code, being configured to cause the apparatus to:
determine a delay value of a receiver path, via which a Reply to Office Action dated February 8, 2013 positioning-related signal is received, on the basis of at least one reception parameter,
measure a timing value for timing-based positioning calculation on the basis of the received positioning-related signal, and
correct the measured timing value on the basis of the determined delay value of the receiver path,
wherein the at least one reception parameter comprises.

11. The apparatus according to claim 10, wherein the at least one processor, with the at least one memory and the computer program code, is configured to cause the apparatus to:
detect the at least one reception parameter used in receiving the positioning-related signal,
identify a receiver path configuration corresponding to the detected at least one reception parameter, and
decide the delay value on the basis of the identified receiver path configuration.

12. The apparatus according to claim 11, wherein the at least one processor, with the at least one memory and the computer program code, is configured to cause the apparatus to:
decide the delay value on the basis of the identified receiver path configuration by using a relationship defined on the basis of at least one of a mathematical model and performance measurement results, and/or
decide the delay value by looking up the delay value as a function of the identified receiver path configuration in a look-up table, and/or
identify the receiver path configuration by looking up the receiver path configuration as a function of the detected at least one reception parameter in a look-up table.

13. (canceled)

14. The apparatus according to claim 10, wherein the at least one processor, with the at least one memory and the computer program code, is configured to cause the apparatus to signal the corrected timing value towards a network side for timing-based positioning calculation,
wherein the signaled corrected timing value relates to the receiver path via which the positioning-related signal is received, or the signaled corrected timing value relates to the receiver path of multiple receiver paths via which the positioning-related signal is received, which exhibits the best timing accuracy among the multiple receiver paths, or the signaled corrected timing value is weighted with a weight being indicative of the timing accuracy of the receiver path via which the positioning-related signal is received, and/or
the timing value comprises an observed time difference of arrival with respect to a reference cell, and/or
the positioning-related signal comprises a positioning reference signal from one of a serving cell and a neighboring cell.

15. The apparatus according to claim 10, wherein the at least one processor, with the at least one memory and the computer program code, is configured to cause the apparatus to utilize the corrected timing value for timing-based positioning calculation,
wherein the utilized corrected timing value relates to the receiver path via which the positioning-related signal is received, or the utilized corrected timing value relates to the receiver path of multiple receiver paths via which the positioning-related signal is received, which exhibits the best timing accuracy among the multiple receiver paths, or the utilized corrected timing value is weighted with a weight being indicative of the timing accuracy of the receiver path via which the positioning-related signal is received, and/or
the timing value comprises a signal propagation time with respect to a positioning satellite, and/or
the positioning-related signal comprises a positioning reference signal from a positioning satellite.

16. The apparatus according to claim 10, wherein the at least one processor, with the at least one memory and the computer program code, is configured to cause the apparatus to:
estimate a residual timing error between the corrected timing value and an actual timing value, and
signal the estimated residual timing error towards a network side for timing-based positioning calculation or utilize the estimated residual timing error for timing-based positioning calculation.

17. The apparatus according to claim 10, wherein the at least one processor, with the at least one memory and the computer program code, is configured to measure the timing value by using one of an intra-frequency or single-carrier measurement, an inter-frequency or multiple-carrier measurement and a measurement on carrier aggregation components, and/or
the delay value of the receiver path represents a delay caused by receiver hardware and/or software between a reference point for timing value measurement and a point of timing value measurement in the receiver path.

18. The apparatus according to claim 10, wherein
the apparatus is operable as or at a terminal, user equipment, mobile station or modem, and/or
the apparatus is operable in at least one of a LTE and a LTE-A cellular system.

19. A non-transitory computer readable storage medium comprising computer-executable computer program code which, when the program code is run on a computer, is configured to cause the computer to carry out the method according to claim 1.

20. (canceled)

21. The method according to claim 1, wherein the at least one reception parameter further comprises a number of subcarriers at an operating bandwidth.

22. The method according to claim 1, wherein the at least one reception parameter further comprises an active receiver function setup.

23. The method according to claim 1, wherein the at least one reception parameter further comprises an active receiver front-end setup.

24. The apparatus according to claim 10, wherein the at least one reception parameter further comprises a number of subcarriers at an operating bandwidth.

25. The apparatus according to claim 10, wherein the at least one reception parameter further comprises an active receiver function setup.

26. The apparatus according to claim 10, wherein the at least one reception parameter further comprises an active receiver front-end setup.

27. A method comprising:
determining a delay value of a receiver path, via which a positioning-related signal is received, on the basis of at least one reception parameter,
measuring a timing value for timing-based positioning calculation on the basis of the received positioning-related signal, and
correcting the measured timing value on the basis of the determined delay value of the receiver path,
wherein the at least one reception parameter comprises a number of subcarriers at an operating bandwidth.

28. An apparatus comprising:
at least one processor,
at least one memory including computer program code, and
at least one interface configured for communication with at least another apparatus,
the at least one processor, with the at least one memory and the computer program code, being configured to cause the apparatus to:
determine a delay value of a receiver path, via which a positioning-related signal is received, on the basis of at least one reception parameter,
measure a timing value for timing-based positioning calculation on the basis of the received positioning-related signal, and
correct the measured timing value on the basis of the determined delay value of the receiver path,
wherein the at least one reception parameter comprises a number of subcarriers at an operating bandwidth.
